(19) United States
(12) Patent Application Publication
(10) Pub. No.: US 2012/0242505 A1
(43) Pub. Date: Sep. 27, 2012

(54) ROAD-VEHICLE COOPERATIVE DRIVING SAFETY SUPPORT DEVICE

(76) Inventors: Takashi Maeda, Tokyo (JP); Shigeki Morita, Tokyo (JP)

(21) Appl. No.: 13/514,112

(22) PCT Filed: Mar. 16, 2010
(86) PCT No.: PCT/JP2010/001870

§ 371 Date: Jun. 6, 2012

(51) Int. Cl. G08G 1/0967

(52) U.S. Cl. 340/905

(57) ABSTRACT

When a decision is made that it is necessary to call driver's attention as a result of analyzing driving safety support information received by a roadside device information receiving unit 34 and vehicle driving state information detected by a vehicle state detecting unit 33, an attention-calling screen, in which a target detection area including an obstacle is superimposed upon a corresponding map information, is displayed.

### TECHNICAL FIELD

The present invention relates to a road-vehicle cooperative driving safety support device preferably used for an onboard device such as a navigation system, which attracts attention as next generation safety technology and is undergoing a verification experiment.

### BACKGROUND ART

A road-vehicle cooperative driving safety support system, which detects obstacle information about a car, two-wheeled vehicle, pedestrian and the like at a position difficult for a driver to perceive with a sensor placed at a roadside, which provides the detection information to an onboard device (road-vehicle cooperative driving safety support device), and which causes the onboard device to excite attention of the driver, has been studied and put to practical use. In this case, the onboard device receives driving safety support system (DSSS) data from an infrared beacon roadside device or dedicated short range communication (DSRC) roadside device installed on a road, analyzes the driving state of the vehicle and the content of the DSSS data about the obstacle information the roadside sensor detects, and calls driver's attention.

The conventional road-vehicle cooperative driving safety support device, however, calls driver's attention by outputting an image and a voice. In particular, to try to excite attention with an image, as in a VICS (Vehicle Information and Communication System) (trademark: the mention of which will be omitted from now on), for example, calling driver's attention is made by displaying a simple figure consisting of a sign such as “pedestrian crossing” near the traveling road on a navigation screen. Accordingly, when a road shape is complicated or when a plurality of services such as facility information are drawn on the same intersection, it has a problem in that the driver cannot easily perceive the road to which the driver has to pay attention or an obstacle like a pedestrian or oncoming vehicle.

On the other hand, a danger information providing device has been known conventionally which uses vehicle-to-vehicle communication and excites attention of a driver by drawing information like an oncoming vehicle acquired by means of the vehicle-to-vehicle communication on a navigation map, and which draws, when no oncoming vehicle or the like is detected, the road that is decided as dangerous on the navigation map (see Patent Document 1, for example).

### PRIOR ART DOCUMENT

### Patent Document

Patent Document 1: Japanese Patent Laid-Open No. 2003-256986.

### DISCLOSURE OF THE INVENTION

According to the technique disclosed in the foregoing Patent Document 1, although the foregoing problem is solved, when accuracy of position information about the oncoming vehicle or the like acquired is not enough, it has a danger of leading to an operating error because it may provide the driver with a wrong position of the obstacle. In addition, because it draws each vehicle or a group of vehicles as a “point” on a map as shown in FIG. 10 of the Patent Document 1, the driver cannot grasp the situation immediately when the number of vehicles is great, and must pay close attention to it. Furthermore, although it draws a danger area when no vehicle is detected, it has a problem in this case of being unable to distinguish between a case where no vehicle is present and a case where no vehicle can be detected because of a failure of a communication device.

The present invention is implemented to solve the foregoing problems. Therefore it is an object of the present invention to provide a road-vehicle cooperative driving safety support device capable of improving visibility of information about an obstacle to be paid attention, and of reducing the effect due to inaccuracies of the position detected with the roadside sensor.

A road-vehicle cooperative driving safety support device in accordance with the present invention is a device that displays an attention-calling screen via communication with at least one roadside device, and that comprises: a roadside device information receiving unit for receiving from the roadside device driving safety support information including an obstacle present in a target detection area; a vehicle state detecting unit for detecting vehicle driving state information including a current vehicle position; and a control unit for deciding on whether it is necessary to call driver's attention or not by analyzing the driving safety support information received by the roadside device information receiving unit and the vehicle driving state information detected by the vehicle state detecting unit, for extracting, when deciding that it is necessary to call driver's attention, the target detection area in which the obstacle is present, and for causing a display device to display the attention-calling screen by superimposing the extracted target detection area upon corresponding map information.

According to the present invention, when deciding that it is necessary to call driver's attention as a result of analyzing the driving safety support information received by the roadside device information receiving unit and the vehicle driving state information detected by the vehicle state detecting unit, the device displays the attention-calling screen that has the target detection area, in which the obstacle is present, superimposed upon the corresponding map information. Accordingly, the driver can grasp the area that requires the driver's attention to avoid a collision, for example. In addition, it can reduce the influence due to the inaccuracy of a position sensor because the target area is displayed in the form of an area rather than a point.

### BRIEF DESCRIPTION OF THE DRAWINGS

FIG. 1 is a diagram showing an example of a communication infrastructure for implementing a road-vehicle cooperative driving safety support system;

FIG. 2 is a block diagram showing a configuration of a road-vehicle cooperative driving safety support device of an embodiment 1 in accordance with the present invention;

FIG. 3 is a block diagram showing a structure of a program the control unit of the embodiment 1 in accordance with the present invention executes with its functions being developed;

FIG. 4 is a flowchart showing the operation of the embodiment 1 in accordance with the present invention;

FIG. 5 is a diagram showing an attention-calling screen created by the embodiment 1 in accordance with the present invention;

FIG. 6 is a flowchart showing the operation of an embodiment 2 in accordance with the present invention;

FIG. 7 is a diagram showing an attention-calling screen created by the embodiment 2 in accordance with the present invention;

FIG. 8 is a flowchart showing the operation of an embodiment 3 in accordance with the present invention;

FIG. 9 is a diagram showing an attention-calling screen created by the embodiment 3 in accordance with the present invention; and

FIG. 10 is a diagram showing an attention-calling screen created by an embodiment 4 in accordance with the present invention;

### EMBODIMENTS FOR CARRYING OUT THE INVENTION

The best mode for carrying out the invention will now be described with reference to the accompanying drawings to explain the present invention in more detail.

### Embodiment 1

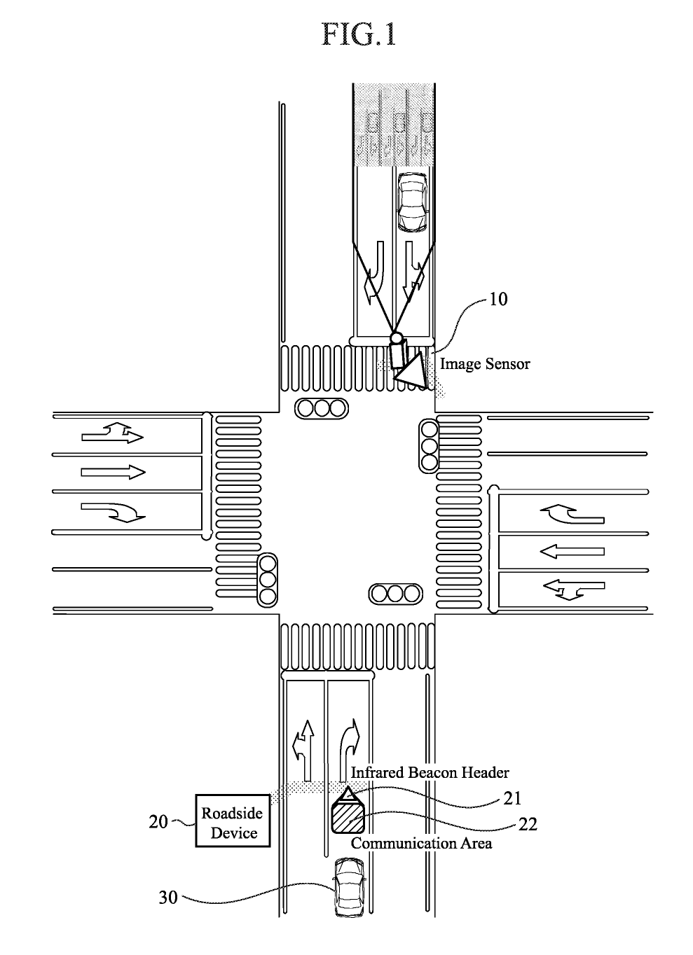

FIG. 1 is a diagram showing an example of a communication infrastructure for implementing a driving safety support system based on road-vehicle communication. Referring to FIG. 1, an infrastructure in cooperation with an infrared beacon implements the road-vehicle communication. More specifically, an image sensor 10 installed on a roadside cuts out through image processing an image of an obstacle including a vehicle and pedestrian from an image of a target detection area taken by the camera, calculates information about the speed and position of the obstacle, and transmits it to a roadside device 20. The roadside device 20 which receives it adds, to the obstacle information received from the image sensor 10, DSSS data including the shape data about the intersection and light color information of a traffic signal operating at the intersection and transmits from an infrared beacon header 21. Then, in the vehicle traveling across a communication area 22 of the infrared beacon header 21, its road-vehicle cooperative driving safety support device (onboard device 30) receives the DSSS data and creates and displays attention-calling screen information using multimedia, thereby calling driver's attention.

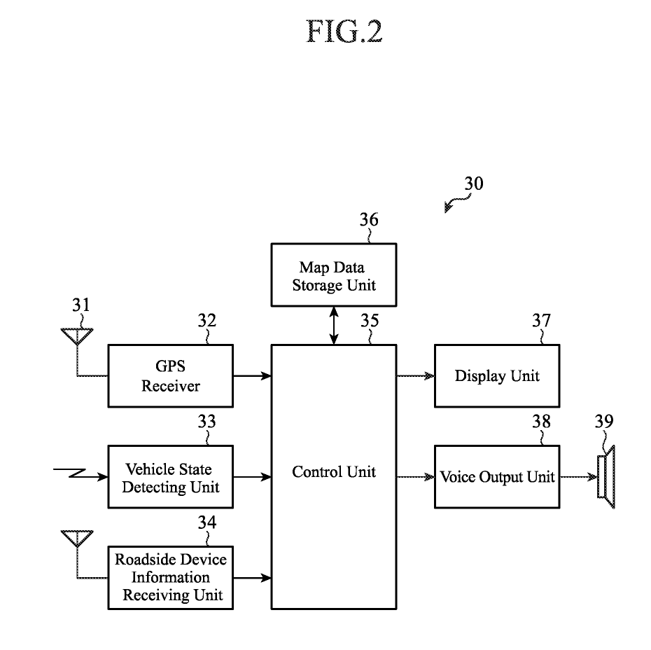

FIG. 2 is a block diagram showing a configuration of the road-vehicle cooperative driving safety support device of the embodiment 1 in accordance with the present invention. In FIG. 2, the onboard device 30 comprises a GPS (Global Positioning System) antenna 31, a GPS receiver 32, a vehicle state detecting unit 33, a roadside device information receiving unit 34, a control unit 35, a map data storage unit 36, a display unit 37, a voice output unit 38 and a speaker 39.

The GPS receiver 32 is connected with the GPS antenna 31, receives positioning information on latitude, longitude and time from GPS satellites, and supplies it to the control unit 35. The vehicle state detecting unit 33 detects vehicle driving state information including the vehicle position and supplies it to the control unit 35. The vehicle state detecting unit 33 is connected to a speed sensor, an acceleration sensor, and brake sensors, for example. The roadside device information receiving unit 34 receives the driving safety support information (DSSS) including information about the obstacle in the target detection area from the roadside device 20 shown in FIG. 1, and supplies it to the control unit 35.

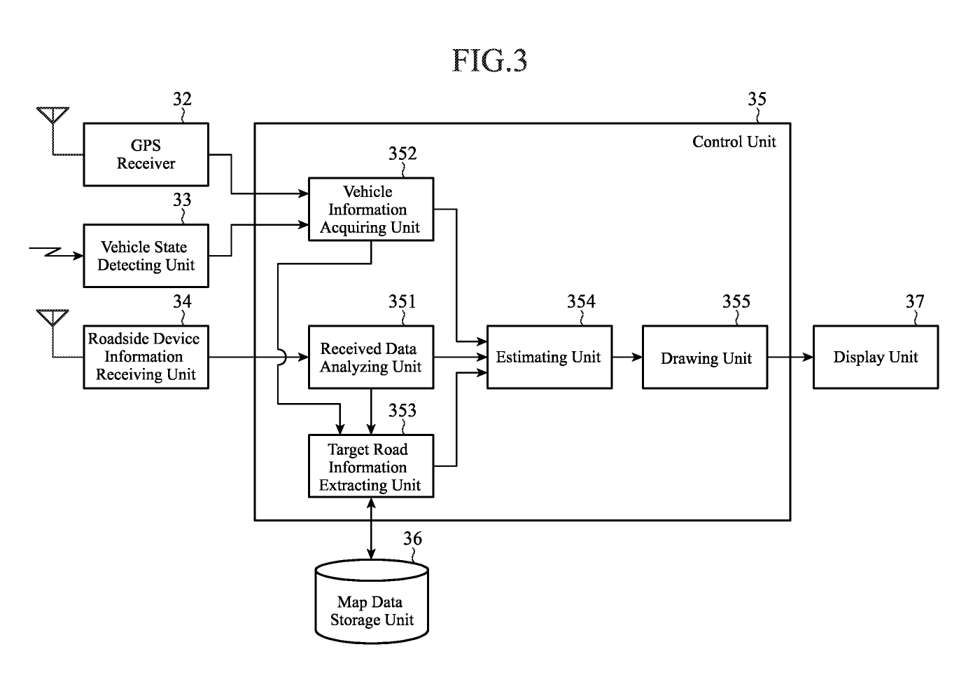

The control unit 35 has functions of analyzing the driving safety support information received via the roadside device information receiving unit 34 and the vehicle driving state information detected by the vehicle state detecting unit 33, of making a decision as to whether it is necessary to call driver's attention or not, of extracting, when decided that it is necessary, the target detection area where the obstacle is present, and of displaying an attention-calling screen in which the extracted target detection area is superimposed upon map information. Accordingly, the control unit 35 comprises, as shown in FIG. 3, for example, a received data analyzing unit 351, a vehicle information acquiring unit 352, a target road information extracting unit 353, an estimating unit 354 and a drawing unit 355.

Incidentally, as for the configuration of the control unit 35 shown in FIG. 3, it does not show hardware of the control unit 35, but shows a structure of programs the control unit 35 executes which is developed according to their functions. The control unit 35, which is composed of a microprocessor in terms of hardware, achieves the foregoing functions by sequentially reading programs stored in an internal or external memory.

The received data analyzing unit 351 extracts obstacle information on another vehicle like an oncoming vehicle, bicycle and pedestrian and information on the detection area of the image sensor 10 by analyzing the DSSS data acquired from the roadside device information receiving unit 34, and delivers them to the estimating unit 354. The vehicle information acquiring unit 352 acquires information on the driving state such as a vehicle speed and steering angle including the present position of the vehicle detected by the GPS receiver 32 and vehicle state detecting unit 33 and delivers it to the estimating unit 354. The target road information extracting unit 353, being linked with the obstacle information analyzed by the received data analyzing unit 351 and the present position of the vehicle acquired by the vehicle information acquiring unit 352, respectively, acquires a map road on which an obstacle is present ahead of the vehicle and which has to call driver's attention, and delivers it to the estimating unit 354.

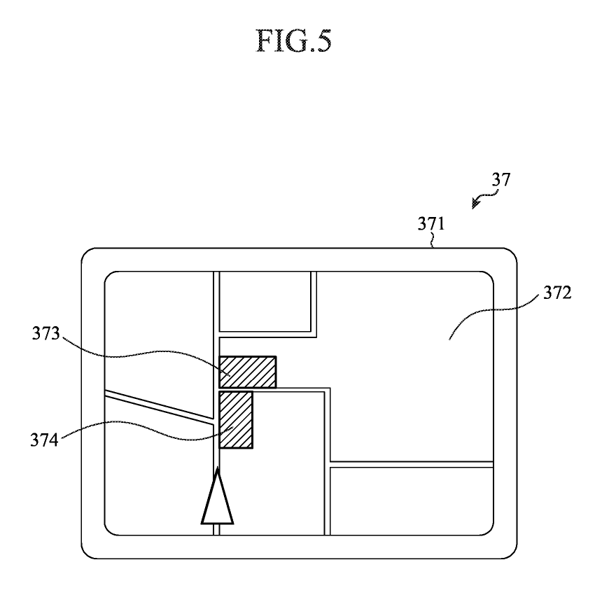

According to the individual information items obtained from the received data analyzing unit 351, vehicle information acquiring unit 352 and target road information extracting unit 353, the estimating unit 354 calculates estimated transit time of the vehicle and of the obstacle such as another vehicle through the intersection, decides the necessity for calling driver's attention by comparing the calculation results, creates, when decided that it is necessary, the attention-calling screen information in which the target detection area extracted is superimposed upon the corresponding map information, and starts the drawing processing of the drawing unit 355. The drawing unit 355 develops the attention-calling screen information created by the estimating unit 354 on a display memory not shown, reads from the display memory the drawn attention-calling screen information in synchronism with the display timing of the display unit 37, and supplies it to the display unit 37. This enables the display unit 37 to display on the monitor the attention-calling screen illustrated in FIG. 5 on. Incidentally, the display memory can be installed in or outside the drawing unit 355 or can be installed in the display unit 37.

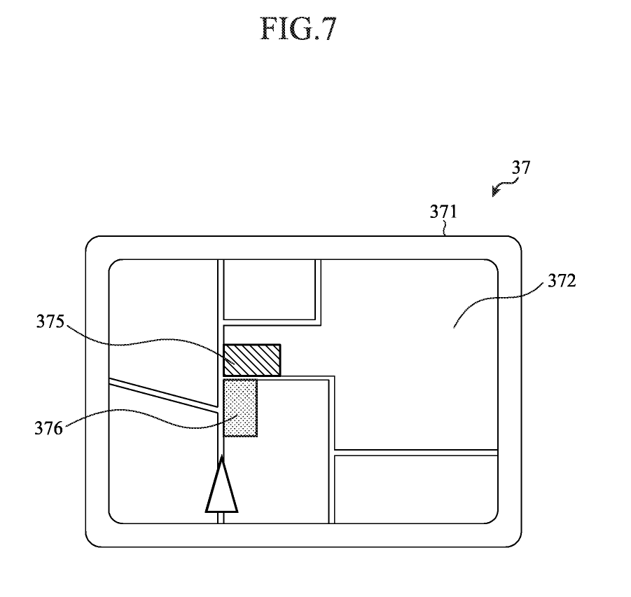

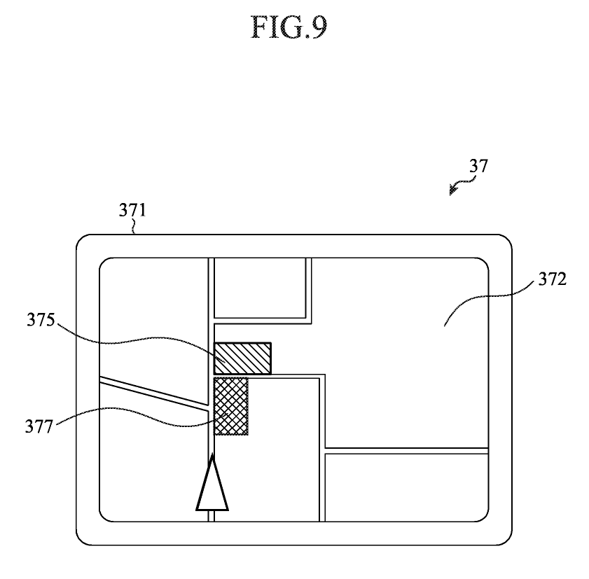

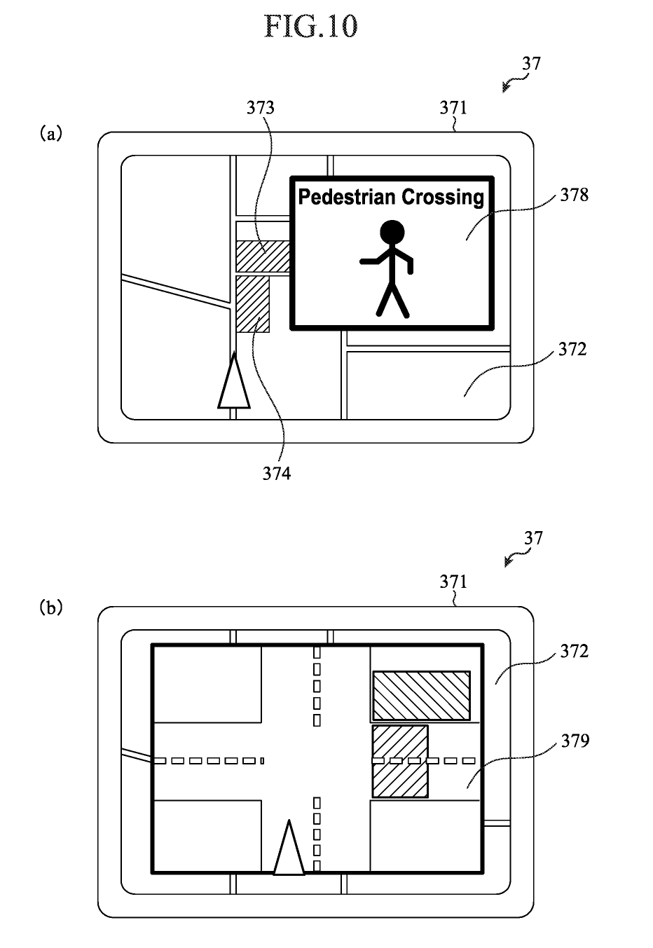

Returning to FIG. 2, again, the map data storage unit 36 stores facility information and the like in addition to the map data such as roads. The map data storage unit 36 is a mass storage device such as a DVD or HD loaded in a DVD (Digital Versatile Disc) drive or HDD (Hard Disc Drive), for example. The display unit 37 is a display device for displaying information created by the control unit 35, and displays an attention-calling screen, an example of a screen arrangement of which is shown in FIG. 5, FIG. 7, FIG. 9 and FIG. 10 which will be described later, for example. The display unit 37 is constructed by using a light-emitting device such as an LCD (Liquid Crystal Display) and organic EL (Electro Luminescent) display consisting of a lot of pixels (combinations of light-emitting elements with a plurality of colors) placed in a matrix, for example. The voice output unit 38 supplies the speaker 39 with a voice such as route guide information and attention-calling information created by the control unit 35.

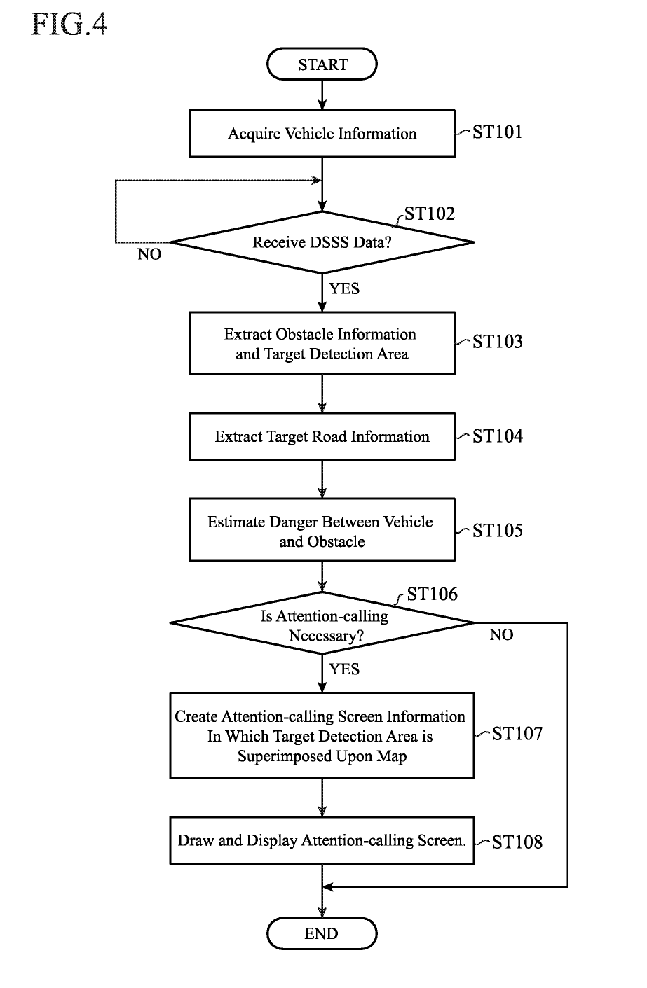

The operation of the road-vehicle cooperative driving safety support device shown in FIG. 1-FIG. 3 will be described in detail below with reference to the flowchart shown in FIG. 4.

The onboard device 30 acquires the vehicle information at a moment when the ignition switch is turned on. The vehicle state detecting unit 33 monitors the driving state of the vehicle such as the vehicle speed and steering angle via sensors mounted on various portions of the vehicle. In addition, the GPS receiver 32 receives the information on latitude, longitude and time necessary for positioning of the vehicle. In the control unit 35, the vehicle information acquiring unit 352 acquires the present position information from the GPS receiver 32 and the information on the driving state of the vehicle from the vehicle state detecting unit 33 and delivers them to the estimating unit 354 (step ST101).

Subsequently, when the vehicle enters the communication area 22 of the infrared beacon, the roadside device information receiving unit 34 receives the DSSS data from the roadside device 20 via the infrared beacon header 21 (“YES” at step ST102). Receiving it, the control unit 35 starts the analysis processing of the DSSS data by the received data analyzing unit 351. Here, the received data analyzing unit 351 extracts the obstacle information including another vehicle, and the target detection area of the obstacle from the received DSSS data, and delivers them to the estimating unit 354 (step ST103). Subsequently, in the control unit 35, being linked with the obstacle information to be analyzed by the received data analyzing unit 351 and the present position of the vehicle acquired by the vehicle information acquiring unit 352, respectively, the target road information extracting unit 353 acquires the road information that has to call driver's attention such as an intersection, a right or left turn, a stop and a fork, where an obstacle is present ahead of the vehicle, and delivers it to the estimating unit 354 (step ST104).

Next, the estimating unit 354, which acquires the information on the present position and vehicle speed from the vehicle information acquiring unit 352, acquires the obstacle information and target detection area information from the received data analyzing unit 351 and acquires the road information that has to call driver's attention such as information on the intersection from the target road information extracting unit 353, makes a danger estimate between the vehicle and the obstacle (step ST105). More specifically, the estimating unit 354 calculates estimated transit time of each other vehicle present on the target road cut out from the detection area, and calculates the estimated traveling time of the vehicle of interest to the intersection in accordance with the distance from the present position of the vehicle to the intersection and the speed of the vehicle. Furthermore, the estimating unit 354 calculates the estimated transit time through the intersection with respect to the present time. As for each of the other vehicles present on the target road, the estimating unit 354 also calculates the estimated transit time between the present position and the intersection. Then, it calculates the absolute value of the difference between the estimated traveling time of the vehicle of interest and the estimated traveling time of the other vehicles, and decides other vehicles with a difference within a threshold. Then, according to the direction of travel of each vehicle analyzed by the received data analyzing unit 351, the estimating unit 354 makes a decision as to whether the vehicle of interest and the other vehicles travel in cross directions at the intersection or not, and decides that it is necessary to call driver's attention by recognizing, when there is any other vehicle traveling in the direction crossing the traveling direction of the vehicle of interest, that it is likely to cause a collision between the vehicle of interest and the other vehicle.

If a decision is made through the foregoing procedure that it is necessary to call driver's attention (“YES” at step ST106), the estimating unit 354 creates the attention-calling screen information in which the target detection area is superimposed upon the map, and delivers it to the drawing unit 355 (step ST107). Receiving it, the drawing unit 355 makes a drawing (bitmap development) of the attention-calling screen information created by the estimating unit 354 on the display memory not shown, reads the attention-calling screen information drawn on the display memory in synchronism with display timing of the display unit 37, and displays on the display unit 37 the attention-calling screen, an example of the screen arrangement of which is shown in FIG. 5, for example, (step ST108).

FIG. 5 shows a map 372 drawn on a display area 371 of the display unit 37, and on the map 372 are displayed target detection areas 373 and 374 of the image sensor 10, in which an obstacle (such as a crossing pedestrian) is present. In this case, a voice is produced from the speaker 39 via the voice output unit 38 to call driver's attention at the same time.

According to the road-vehicle cooperative driving safety support device (onboard device 30) of the above-mentioned embodiment 1, the control unit 35 makes a decision as to whether it is necessary to call driver's attention or not by analyzing the driving safety support information (DSSS) received by the roadside device information receiving unit 34 and the vehicle driving state information detected by the vehicle state detecting unit 33, and extracts, if a decision is made that it is necessary to call driver's attention, the target detection area where an obstacle is present, and displays the attention-calling screen in which the target detection area extracted is superimposed upon the corresponding map information. Accordingly, the driver can easily grasp an area that calls his or her attention to avoid a collision. In addition, the effect due to inaccuracies of the position detected with the roadside sensor can be reduced by carrying out area display rather than point display.

Incidentally, when displaying the target detection area that has to call driver's attention on the display unit 37, according to a degree of collision danger represented in terms of the number of obstacles and speed detected, it can be displayed emphatically in a different display mode from detection areas of the other roadside devices. In this case, it is conceivable that the control unit 35 uses as parameters the number of obstacles and/or the vehicle speed obtained by the analysis of the driving safety support information (DSSS) received by the roadside device information receiving unit 34 and the vehicle speed detected by the vehicle state detecting unit 33, assigns the degree of collision danger step-by-step in accordance with the degree of the parameters, and displays the target detection areas extracted in colors separately in accordance with the degree of collision danger decided, for example. Thus, the driver can grasp the degree of danger by only perceiving the colors. Incidentally, as for the display mode, a configuration is also possible which highlights the target detection areas detected by means of shades, blinking, patterns instead of colors.

### Embodiment 2

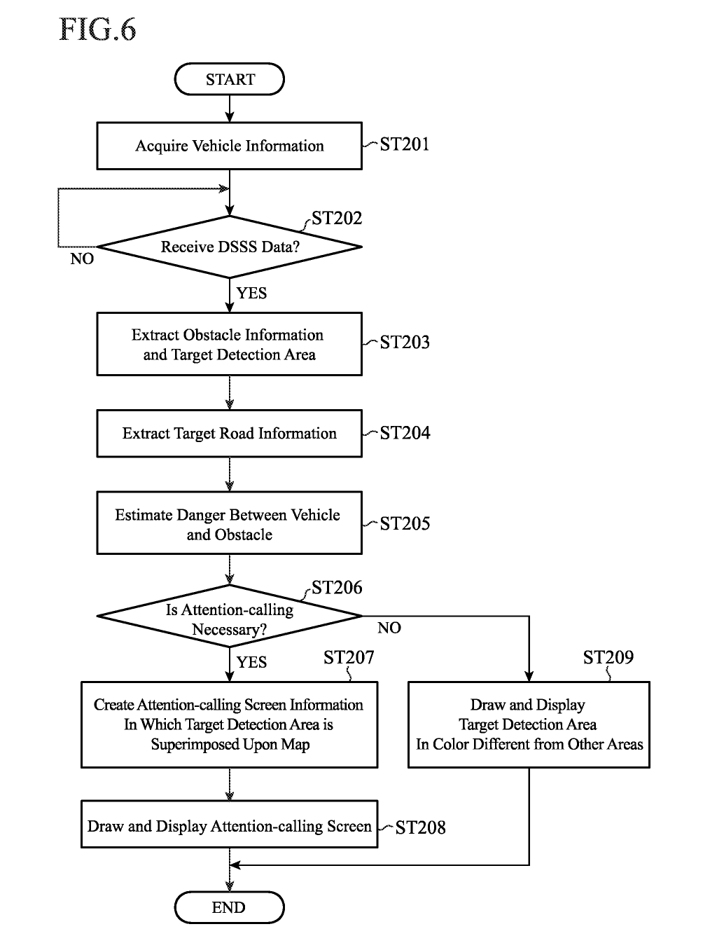

FIG. 6 is a flowchart showing the operation of a road-vehicle cooperative driving safety support device of an embodiment 2 in accordance with the present invention. It is assumed that the road-vehicle cooperative driving safety support device of the embodiment 2 which will be described below has the same configuration as the onboard device 30 shown in FIG. 2 and the control unit 35 shown in FIG. 3 of the embodiment 1. Referring to the flowchart of FIG. 6, the operation of the road-vehicle cooperative driving safety support device of the embodiment 2 will be described below, paying attention to differences from the embodiment 1.

As for the operation steps in which the vehicle information acquiring unit 352 acquires information on the position and vehicle state, the received data analyzing unit 351 analyzes the DSSS data received from the roadside device information receiving unit 34, and the estimating unit 354 makes a danger estimate for calling driver's attention (steps ST201-ST205), they are the same to the corresponding step ST101-ST105 of the embodiment 1. In addition, as for the operation steps in the case where a decision is made that it is necessary to call driver's attention in the attention-calling necessity decision processing at step ST206, that is, the step of creating the attention-calling screen information in which the target detection area is superimposed upon the map and of drawing it on the display memory and the step of displaying the attention-calling screen on the display unit 37 (“YES” at step ST206-ST208), since they are the same as “YES” at step ST106-ST108 in the embodiment 1, their detailed description will be omitted to avoid duplicate explanation.

In the attention-calling necessity decision processing at step ST206, if the estimating unit 354 decides that no obstacle is present in the target detection area of the image sensor 10 and hence it is not necessary to call driver's attention (“NO” at step ST206), then it creates display information for displaying the target detection area in a different color from the other detection areas and delivers it to the drawing unit 355. Receiving it, the drawing unit 355 makes a drawing (bitmap development) of the display information created by the estimating unit 354 on the display memory not shown, reads the display information drawn on the display memory in synchronism with display timing of the display unit 37, and displays on the display unit 37 the attention-calling screen, an example of the screen arrangement of which is shown in FIG. 7, for example, (step ST209).

FIG. 7 shows a map 372 drawn on a display area 371 of the display unit 37, and even if no obstacle (such as a crossing pedestrian) is present on the map 372, the target detection area 375 of the image sensor 10 is displayed in a color different from the other detection area 376. This makes it possible to call driver's attention by providing the driver with the detection area of the image sensor 10 even if no obstacle is present.

According to the road-vehicle cooperative driving safety support device of the above-mentioned embodiment 2, the control unit 35 makes a decision as to whether it is necessary to call driver's attention or not by analyzing the driving safety support information (DSSS) received by the roadside device information receiving unit 34 and the vehicle driving state information detected by the vehicle state detecting unit 33, and displays the target detection area extracted in a display mode different from the other detection areas even if a decision is made that it is not necessary to call driver's attention, thereby being able to call driver's attention. Incidentally, as for the display mode, it is also possible to distinguish it from the others by means of shades, patterns, blinking and the like.

### Embodiment 3

According to the above-mentioned embodiment 2, even if there is no obstacle in the target detection area, it draws the detection area in a color different from colors of the other detection areas. In this case, however, it cannot distinguish between the case where no obstacle is present and the case where no obstacle is detected because of a communication abnormality on the side of the roadside device 20 including the image sensor 10. Accordingly, although the embodiment 3 which will be described below employs nearly the same configuration as the embodiment 2 with respect to the onboard device 30 of FIG. 2 and the control unit 35 of FIG. 3, it differs in that when the received data analyzing unit 351 detects a communication abnormality, the estimating unit 354 creates the display information for drawing the target detection area it extracts in a color different from colors of the other detection areas, thereby distinguishing in its display the case where no obstacle is detected because of the communication abnormality.

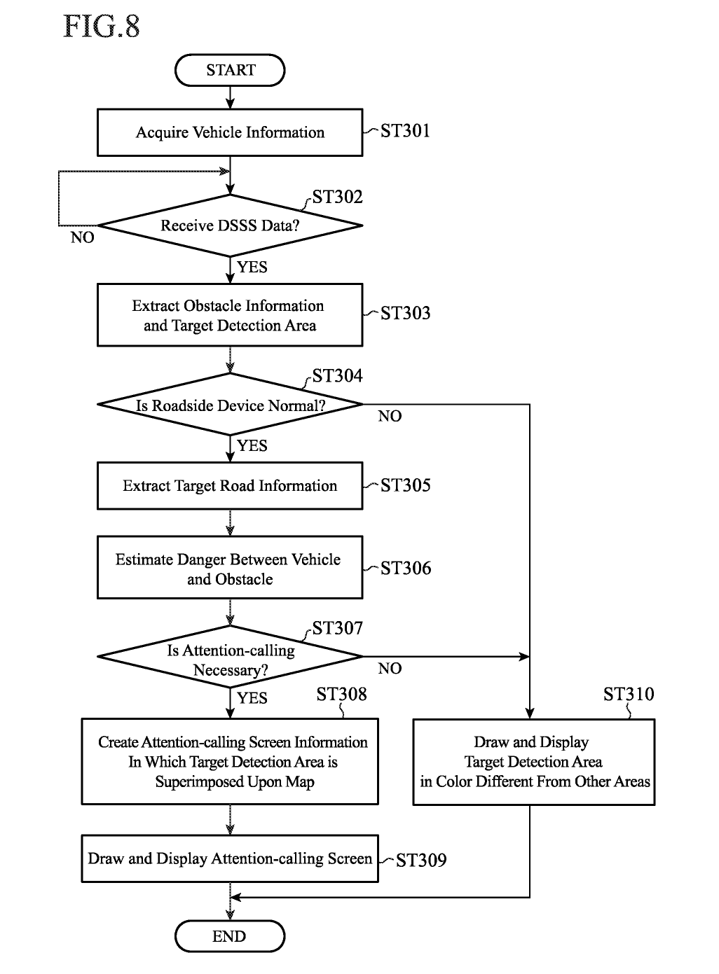

FIG. 8 is a flowchart showing the operation of the road-vehicle cooperative driving safety support device of the embodiment 3 in accordance with the present invention. Referring to the flowchart of FIG. 8, the operation of the road-vehicle cooperative driving safety support device of the embodiment 3 will be described below, paying attention to differences from the embodiment 2.

In the control unit 35, unless the received data analyzing unit 351 detects a communication abnormality on the side of the roadside device 20 including the image sensor 10 (“YES” at step ST304), the estimating unit 354 makes a danger estimate for calling driver's attention in the same manner as the embodiment 2 from the information on the vehicle state acquired from the vehicle information acquiring unit 352 and the DSSS data the received data analyzing unit 351 analyzes (step ST306). Then, if a decision is made that it is necessary to call driver's attention (“YES” at step ST307), the estimating unit 354 creates the attention-calling screen information in which the target detection area is superimposed upon on the map, draws it on the display memory, and displays the attention-calling screen on the display unit 37 (“YES” at step ST307-ST309). On the other hand, if the estimating unit 354 makes a decision that there is no obstacle in the target detection area of the image sensor 10, and hence it is not necessary to call driver's attention, it creates the display information for displaying the target detection area in a color different from colors of the other detection areas and delivers it to the drawing unit 355, and the drawing unit 355 which receives it makes a drawing (bitmap development) of the display information created by the estimating unit 354 on the display memory not shown, reads the display information drawn on the display memory in synchronism with display timing of the display unit 37, and displays on the display unit 37 (“NO” at step ST307 and ST310).

If the received data analyzing unit 351 detects a communication abnormality or a roadside device abnormality (“NO” at step ST304), the estimating unit 354 creates the display information for drawing the extracted target detection area in a color different from colors of the other detection areas, and delivers it to the drawing unit 355. Receiving it, the drawing unit 355 makes a drawing (bitmap development) of the display information created by the estimating unit 354 on the display memory not shown, reads the display information drawn on the display memory in synchronism with display timing of the display unit 37, and displays the attention-calling screen, an example of the screen arrangement of which is shown in FIG. 9, for example, (step ST310).

FIG. 9 shows the map data 372 drawn on a display area 371 of the display unit 37, and a target detection area 375, as to which a decision is made that there is no obstacle therein, and which is drawn on the map 372 in a prescribed color. Apart from it, a target detection area 377 as to which a communication abnormality is detected is highlighted in a conspicuous color different from that of the target detection area 375 displayed in the prescribed color. As a result, the driver can distinguish between the target detection areas extracted in the case where no obstacle is present and in the case where the communication abnormality is detected.

According to the road-vehicle cooperative driving safety support device of the above-mentioned embodiment 3, if the control unit 35 analyzes the driving safety support information received by the roadside device information receiving unit 34 and detects an abnormality on the side of the roadside device 20 including the image sensor 10, it highlights the extracted target detection area in a display mode different from that of the other detection areas. Accordingly, it enables the driver to distinguish between the case where no obstacle is present and the case where no obstacle can be detected because of the communication abnormality, thereby being able to prevent an operating error and to contribute to safe driving.

### Embodiment 4

FIG. 10(a) is a diagram showing an attention-calling screen arrangement displayed by the road-vehicle cooperative driving safety support device of an embodiment 4 in accordance with the present invention. Although the embodiment 4 which will be described below employs nearly the same configuration as the above-mentioned embodiments 1-3 with respect to the onboard device 30 shown in FIG. 2 and the control unit 35 shown in FIG. 3, it differs in that the estimating unit 354 creates display information that combines the attention-calling screen created according to one of the embodiments 1, 2 and 3 with a sign image known on a VICS screen, and the drawing unit 355 draws and displays it.

Referring to FIG. 10(a), a target detection area 374 including an obstacle is displayed on the map data 372 drawn on a display area 371 of the display unit 37, and in addition a sign image 378 “pedestrian crossing” is synthesized and displayed.

According to the road-vehicle cooperative driving safety support device of the above-mentioned embodiment 4, the control unit 35 displays an additional sign image for calling driver's attention near the target detection area extracted by analyzing the driving safety support information received by the roadside device information receiving unit 34. Accordingly, the driver can grasp an area that requires his or her attention for avoiding a collision. In addition, the influence due to the inaccuracy of the position sensor can be reduced by an area display. Furthermore, since the sign image is also displayed, it enables the driver to grasp the current situation more easily. Incidentally, drawing an intersection shape and its area on a sign image 379 without drawing the target detection area on the map data 372 as shown in FIG. 10(b) makes it possible to achieve the same advantage.

Incidentally, as for the functions of the above-mentioned control unit 35, all of them can be implemented by software or at least part of them by hardware. For example, as for the data processing of the control unit 35 that makes a decision as to whether it is necessary to call driver's attention or not by analyzing the driving safety support information received by the roadside device information receiving unit 34 and the vehicle driving state information detected by the vehicle state detecting unit 33, that extracts, when a decision is made that it is necessary to call driver's attention, the target detection area in which an obstacle is present, and that displays the attention-calling screen by superimposing the extracted target detection area upon the corresponding map information, it can be implemented by a single or a plurality of programs on a computer or at least part of it can be achieved by hardware.

In addition, although the above-mentioned embodiments 1-4 create an attention-calling screen by extracting a target detection area in which an obstacle is present using the infrared beacon installed at a roadside, radio equipment such as a DSRC onboard device can replace it. In this case, the device makes an attention calling decision every time it receives the DSSS data from a DSRC roadside device, and updates the attention-calling screen each time.

### INDUSTRIAL APPLICABILITY

A road-vehicle cooperative driving safety support device in accordance with the present invention provides an attention-calling screen that draws on map data an area in which an obstacle is present, which calls driver's attention such as an oncoming vehicle or a pedestrian without displaying a sign image as a VICS screen, and is applicable to a DSSS that provides a driver with the optimum driving support information in real time.

What is claimed is:

1. A road-vehicle cooperative driving safety support device for displaying an attention-calling screen through communication with at least one roadside device, the road-vehicle cooperative driving safety support device comprising:
a roadside device information receiving unit for receiving from the roadside device driving safety support information including an obstacle present in a target detection area;
a vehicle state detecting unit for detecting vehicle driving state information including a current vehicle position; and
a control unit for deciding on whether it is necessary to call driver's attention or not by analyzing the driving safety support information received by the roadside device information receiving unit and the vehicle driving state information detected by the vehicle state detecting unit, for extracting, when deciding that it is necessary to call driver's attention, the target detection area in which the obstacle is present, and for causing a display device to display the attention-calling screen by superimposing the extracted target detection area upon corresponding map information.

2. The road-vehicle cooperative driving safety support device according to claim 1, wherein
the control unit decides a degree of collision danger, which uses as its parameter the number of obstacles and/or vehicle speed obtained by analyzing the driving safety support information received by the roadside device information receiving unit and vehicle speed detected by the vehicle state detecting unit, and causes the display device to highlight the extracted target detection area in a display mode different from a display mode of other detection areas in accordance with the degree of collision danger decided.

3. The road-vehicle cooperative driving safety support device according to claim 1, wherein
the control unit, when deciding that no obstacle is present in the target detection area extracted as a result of analyzing the driving safety support information received by the roadside device information receiving unit, causes the display device to display the extracted target detection area in a display mode different from a display mode of other detection areas.

4. The road-vehicle cooperative driving safety support device according to claim 1, wherein
the control unit, when detecting an abnormality of the roadside device by analyzing the driving safety support information received by the roadside device information receiving unit, causes the display device to indicate the abnormality by displaying the extracted target detection area in a display mode different from a display mode of other detection areas.

5. The road-vehicle cooperative driving safety support device according to claim 1, wherein
the control unit causes the display device to display a sign image for further calling driver's attention near the target detection area extracted by analyzing the driving safety support information received by the roadside device information receiving unit.
